(19) United States
(12) Patent Application Publication
(10) Pub. No.: US 2008/0299509 A1
(43) Pub. Date: Dec. 4, 2008

(54) Duncan transfer band

(76) Inventor: Gary Allan Duncan, Dublin, OH (US)

Correspondence Address: Mr. Gary Allan Duncan, 8831 Locherbie Court, Dublin, OH, 43017, US

(21) Appl. No.: 11/807,366

(22) Filed: May 29, 2007

(51) Int. Cl. A61C 19/00

(52) U.S. Cl. 433/25

(57) ABSTRACT

The Duncan Transfer Band will assist in the process that will allow a surgeon to place a final dental implant restoration immediately after surgery into a patient's mouth that will function in conjunction with the dental implant(s) placed in the mandible and/or maxilla bone(s). The Duncan Transfer Band is used in the manufacturing of a surgical dental implant stent that will allow a surgeon to place a dental implant analogs perfectly parallel to other dental implant analogs as well as teeth. The Duncan Transfer Band is used in the manufacturing of a surgical dental implant stent that will allow a surgeon to place dental implant analogs at a predetermined depth within the mandible and/or maxilla of a patient undergoing surgery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE, A TABLE, OR A COMPUTER PROGRAM LISTING COMPACT DISK APPENDIX

Not Applicable

### BACKGROUND OF THE INVENTION

The Duncan Transfer Band is placed into use during a sequence of steps for the manufacturing of a surgical dental implant stent and is suggested to be placed under Class 433, Dentistry, as this class is a specific class under the broader class of Surgery and includes methods directed to or including specific dental steps whereas the use of this device ultimately facilitates the replacement teeth. The Duncan Transfer Band is suggested to be assigned the Subclass 25, Apparatus, whereas this device or subcombination thereof is for facilitating the replacement, treatment, or testing of either natural of artificial teeth noting that the above apparatus does not remain in the patient's mouth after treatment.

The Duncan Transfer Band is placed into use during the third step in solving notable problems in the process of both favorably manufacturing a surgical dental implant stent in the dental lab as well as ultimately surgically drilling and placing dental implants in the patients mouth using the aforementioned stent. Because the Duncan Transfer Band or anything to serve it's exact purpose has not previously been invented, currently dental implant stents in addition to any other means used by surgeons to place any number of dental implants in a patient's mouth are unable to be manufactured as to allow such surgeons to place a dental implant(s) parallel to other implants or existing teeth on the arch of the mandible or maxilla of a patient undergoing surgery. When a dental implants are not placed parallel to other dental implants, final restorations are much more difficult to manufacture and the longevity of a final restoration is shortened. Without the Duncan Transfer Band and/or the process of its use, surgical dental implant stents are unable to be manufactured as to allow surgeons to drill and to place a dental implant at a predetermined depth decided upon by the surgeon which allows the surgeon to immediately place after surgery the final restoration in a patients mouth that will function in conjunction with dental implants previously placed in the mandible and/or maxilla bone(s) using the aforementioned surgical dental implant stent. When surgeons have no means to accurately follow through with making a fissure to place a dental implant at a predetermined depth, such surgeons when making this fissure will pass through the bone of the mandible or maxilla and be required to find a new site as well as restore the damaged area causing additional time for a patient undergoing the procedure to heal and recover. Currently, surgical dental implant stents are not manufactured as to allow surgeons to immediately after surgery place the final restoration in a patient's mouth.

### BRIEF SUMMARY OF THE INVENTION

The Duncan Transfer Band is placed into use during the third step of manufacturing a dental implant stent. The Duncan Transfer Band is used by placing its internal threads with the mating external threads of the Duncan Transfer Screw, or any device with external screw threads that serves the same purpose as the Duncan Transfer Band, with a twisting motion. The Duncan Transfer Band is machined to have external appendages so as to allow it to be anchored in acrylic for the final manufacturing of a surgical implant stent. The Duncan Transfer Band assists in allowing the ultimate manufacture of a dental implant stent that for the first time will allow a surgeon to control the depth of a fissure made to place dental implants in the mandible and/or maxilla bone(s) of a patient while also placing such dental implants parallel to other dental implants or teeth. The Duncan Transfer Band assists in a process that allows a final dental implant restoration to be placed immediately after surgery in a patient's mouth.

The Duncan Transfer Band assists the manufacturing of the aforementioned surgical dental implant stent and allows dental implants to be placed parallel allowing for increased longevity of a final restoration. The Duncan Transfer Band assists the manufacturing of the aforementioned surgical dental implant stent that also will serve as a guide by only allowing a surgical drill bit device to pass a predetermined measurable depth into a manufactured dental implant stent thus allowing a surgeon to place a dental implant at a predetermined depth in a patient's mandible and or maxilla bone(s) thus leaving no error for correct and desired dental implant placement.

### BRIEF DESCRIPTION OF THE SEVERAL OF THE DRAWING

FIG. 1 is a front view perspective of the Duncan Transfer Band;

FIG. 2 is a side view perspective of the Duncan Transfer Band;

FIG. 3 is a sectional view perspective of the Duncan Transfer Band;

FIG. 4 is an isometric view perspective of the Duncan Transfer Band.

### DETAILED DESCRIPTION OF THE INVENTION

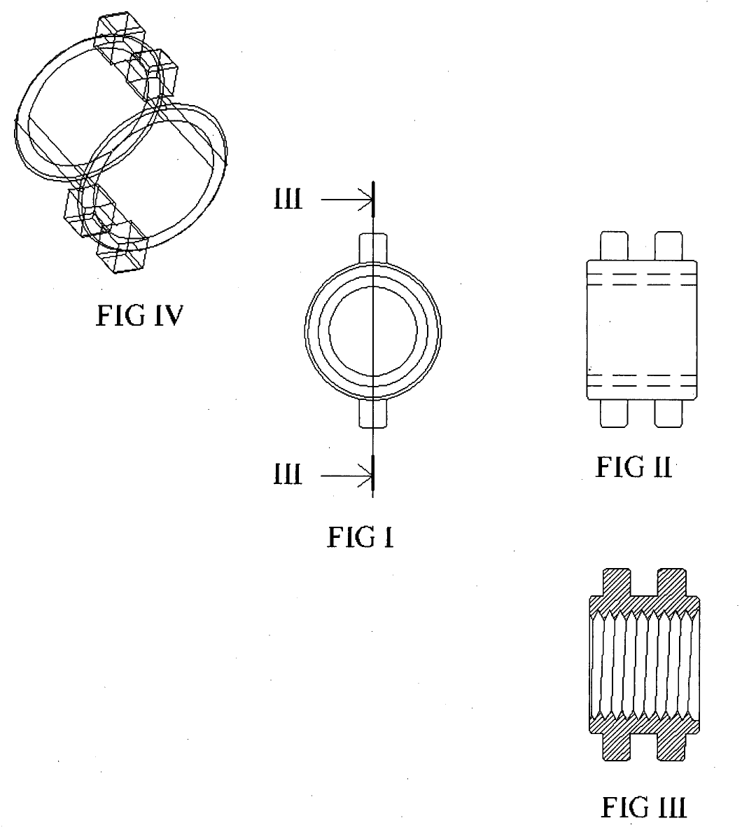

The Duncan Transfer Band is best carried out while used in conjunction with a previously placed Duncan Transfer Screw. Referring to FIG. 1, the Duncan Transfer Band is hollow with internal threads that will mate with external threads of the Duncan Transfer Screw.

Referring to FIG. 2, the Duncan Transfer Band has external appendages that will allow it to be anchored in acrylic after being adjoined with the Duncan Transfer Screw. Referring to FIG. 3, the internal threads of the Duncan Transfer Band will allow the Duncan Transfer Screw to be placed into and taken out of the Duncan Transfer Band after the Duncan Transfer Band is set in acrylic. Referring to FIG. 4, this isometric view displays the design concept of the Duncan Transfer Band as a whole.

The Duncan Transfer Band is the first of it's kind and can be machined out of any surgical metal such as stainless steel or titanium while serving as the best way to carry out the manufacturing of this invention.

What is hereby claimed is:

1. The Duncan Transfer Band is a device that while used in conjunction with various other devices and tools assists in the manufacturing of a surgical dental implant stent.

2. The device defined in claim 1 with mating screw threads, will work in conjunction with the Duncan Transfer Screw.

3. The device defined in claim 1 will allow the Duncan Transfer Screw to easily transfer into and out of the device defined in claim 1.

4. The device defined in claim 1 can be anchored in acrylic so as to allow no movement of any kind.

5. The device defined in claim 1 will allow a designated surgical drill bit to be inserted through its center and create a fissure in the mandible or maxilla bone(s) of a patient undergoing surgery to the exact depth prescribed by a surgeon.

6. The device defined in claim 1 allows a surgical drill to create a fissure in the mandible and/or maxilla bone(s) that is parallel to other placed surgical dental implants.

7. The device defined in claim 1 allows a surgical drill to create a fissure in the mandible and/or maxilla bone(s) that is parallel to teeth.

8. The device defined in claim 1 will allow surgical dental implants to be set in the mandible and/or maxilla bone(s) of a patient undergoing surgery just as they were in a model replicating the said patient's mandible and/or maxilla bone(s) that was made prior to surgery.

9. A surgical drill bit with mating threads as to that of the device defined in claim 1 while the device in claim 1 is set in a manufactured surgical stent, will allow a fissure to be placed in the mandible and/or maxilla bone(s) of a patient undergoing surgery that will then have threads in the said bone(s) that will mate with a surgical dental implant to be placed in the said bone(s).

10. The device defined in claim 1 can be machined to any desired dimension or dimensions desired.

11. The device defined in claim 1 can be machined out of any desired surgical metal.

12. The device defined in claim 1 can be manufactured out of any material used for the purpose of this invention that is accepted by governing bodies of dental surgery and/or dental laboratories.

13. The device defined in claim 1 can be color coded.

14. The device defined in claim 1 will allow for the manufacturing of a surgical dental implant stent that will allow a surgeon to place the final dental implant restoration immediately after surgery into a patient's mouth that will function in conjunction with the dental implant(s) placed in the mandible and/or maxilla bone(s) while using the aforementioned surgical dental implant stent.
